(19) United States
(12) Patent Application Publication
(10) Pub. No.: US 2024/0242558 A1
(43) Pub. Date: Jul. 18, 2024

(54) STIR STICK DISPENSER FOR A BEVERAGE VENDING MACHINE AND METHOD FOR DISPENSING STIR STICKS

(71) Applicant: Evoca S.P.A, Valbrembo (IT)

(72) Inventors: Dan Alexie Sirbu Villa, Valbrembo (IT); Alberto Crippa, Valbrembo (IT)

(21) Appl. No.: 18/559,449

(22) PCT Filed: May 17, 2022
(86) PCT No.: PCT/IB2022/054559

§ 371 Date: Nov. 7, 2023

(30) Foreign Application Priority Data
May 18, 2021 (EP) 21174407.3
Nov. 11, 2021 (IT) 102021000028712

(51) Int. Cl. G07F 11/16; G07F 13/06; G07F 13/10

(52) U.S. Cl. CPC G07F 11/16; G07F 13/065; G07F 13/10

(57) ABSTRACT

Stir stick dispenser and method for dispensing stir sticks in a beverage vending machine, wherein a stir stick is extracted from a stack of stir sticks, is supplied into a drop chute towards a beverage cup and is temporarily stopped in an intermediate point of the drop chute and before the stir stick enters the beverage cup by means of a pendulum member freely oscillating about a reciprocating hinge axis.

### CROSS-REFERENCE TO RELATED APPLICATIONS

This Patent application claims priority from European Patent Application No. 21174407.3 filed on May 18, 2021 and from Italian Patent Application No. 102021000028712 filed on Nov. 11, 2021, the disclosures of which are incorporated herein by reference.

### TECHNICAL FIELD OF THE INVENTION

The present invention relates to a stir stick dispenser for a beverage vending machine and to a method for dispensing stir sticks.

### STATE OF THE ART

In the vending field it is known to arrange inside a beverage vending machine a stir stick dispenser controlled by an electronic control unit of the beverage vending machine in order to dispense a stir stick directly in a cup delivered in a cup filling station to receive the beverage.

The stir stick is normally released in the cup before the cup is filled with the beverage and it can be dispensed only if sugar is required in the selected beverage.

In general, a known stir stick dispenser comprises a stir stick magazine containing one or more columns of orderly stacked stir sticks, and an extractor operated, in use, to move reciprocally and transversally with respect to the stir sticks, through a lower outlet of the stir stick magazine to eject, by a back-and-forth movement through the lower outlet, only the stir stick at the bottom of the stack and to let it fall directly in the cup or on a slide driving it to the cup.

Stir stick dispensers of the kind specified above are known, for example, from EP 1 586 254 A1, EP 2 345 010 A1 and EP 2 563 187 A1.

Stir stick dispensers of the kind specified above have been used for decades in a fairly satisfying way in order to dispense plastic stir sticks, but revealed serious drawbacks as long as plastics was outlawed after recent regulations concerning environment protection came into force, and the operators of this field were obliged to adopt alternative “green” solutions, particularly to use stir sticks made of biodegradable or compostable materials such as wood or paper.

The problems connected with the use of wood or paper stir sticks inside conventional dispensers originate from the fact that, in these dispensers, the extractor, the stir stick magazine and the stack of stir sticks are configured to interact with each other with high precision so that the movement of the extractor allows the extraction of a single stick from the bottom of the stack.

As for plastics stir sticks, such a precision is normally assured over time by the fact that the shape and size of the stir sticks stacked in the stir stick magazine remain substantially stable, regardless of the environmental conditions inside the automatic dispenser.

On the contrary, the same precision cannot be assured in case of stir sticks made of other materials than plastics, particularly wood and paper, since, as known, these materials suffer a lot from temperature and humidity changes, and it can occur that the stir sticks warp to such an extent that the action of the extractor becomes ineffective, thus causing the stir stick dispenser to jam.

The problem of the deformation of the stir sticks is, at least in part, solved by the dispenser described in the Italian patent application No 102021000007343 filed by the current Applicant and in which a back-and-forth movable extractor extracts individual stir sticks time regardless of whether they are deformed or not.

In the known dispensers, regardless of the material with which the stir sticks are made and of their geometry or size, each stir stick, once extracted, is abandoned and let to drop by gravity in a conveying duct, the outlet of which leads the stir stick to the cup.

In some cases, the drop takes place smoothly, hence one end of the stir stick rests correctly at the bottom of the cup, whereas in other cases the drop takes place irregularly and unpredictably, hence bounces and/or jams of the stir stick can often take place in the conveying duct and/or at the mouth of the cup.

The foregoing is essentially attributable to the impossibility in the known dispensers to control the descent motion of the stir stick along the conveying duct and when the stick engages the cup.

The aforementioned problem worsens in case of particularly heavy stir sticks such as those made of wood, but also in case of particularly light stir sticks, such as those made of paper and, in some cases, also for those made of plastic.

Moreover, in case of heavy stir sticks, the stir stick reaches the outlet of the conveying duct and, thus, the cup at a sustained speed hitting in a relatively violent way against the bottom or the side wall of the cup depending on the trajectory or on the path followed during the descent generating noises, sometimes annoying.

### OBJECT AND SUMMARY OF THE INVENTION

The object of the invention is to provide a stir stick dispenser for a beverage vending machine that allows the above-described drawbacks to be overcome.

This object is achieved by a stir stick dispenser for a beverage vending machine, as claimed in the appended claims 1 to 9.

The present invention further relates to a method for dispensing stir sticks.

According to the present invention, a method for dispensing stir sticks is provided, as claimed in the appended claims 10 to 12.

### BRIEF DESCRIPTION OF THE DRAWINGS

The present invention will now be described with reference to the accompanying drawings, which illustrate a non-limiting implementation example thereof, wherein:

FIG. 1 schematically and partially show a beverage vending machine provided with a stir stick dispenser according to a preferred embodiment of the invention;

FIGS. 2 and 3 illustrate, in lateral elevation and in perspective view with parts removed for clarity, the stir stick dispenser shown in FIG. 1 in two different operating conditions;

FIGS. 4 and 5 show, in cross-section and enlarged scale, a detail of the stir stick dispenser shown in FIG. 1 in two different operating positions; and

FIG. 6 shows a variant of the stir stick dispenser according to the invention;

FIGS. 7 and 8 show, partially in section and enlarged scale, a detail of the stir stick dispenser shown in FIG. 6 in two different operating conditions; and

FIGS. 9 and 10 show, in perspective view, a detail of the stir stick dispenser shown in FIG. 6 in two different operating positions.

### DETAILED DESCRIPTION OF PREFERRED EMBODIMENTS OF THE INVENTION

The present invention will now be described in detail with reference to the appended figures to allow a person skilled in the art to produce and use the same. Various modifications to the described embodiments will become immediately apparent to those skilled in the art and the described general principles can be applied to other embodiments and applications without departing from the protective scope of the present invention, as defined in the appended claims. Therefore, the present invention should not be considered limited to the described and illustrated embodiments, but it is intended to have the widest protective scope in accordance with the described and claimed characteristics.

Unless otherwise defined, all technical and scientific terms used herein have the same meaning commonly used by those of ordinary skill in the art of the present invention. In case of a dispute, the present description, comprising the definitions provided, will be binding. Furthermore, the examples are provided only for illustrative purposes and as such they should not be regarded as limiting.

In order to facilitate the understanding of the embodiments herein described, reference will be made to some specific embodiments and specific language will be used to describe them. The terminology used in this document is intended to describe only particular embodiments and is not intended to limit the scope of the present invention.

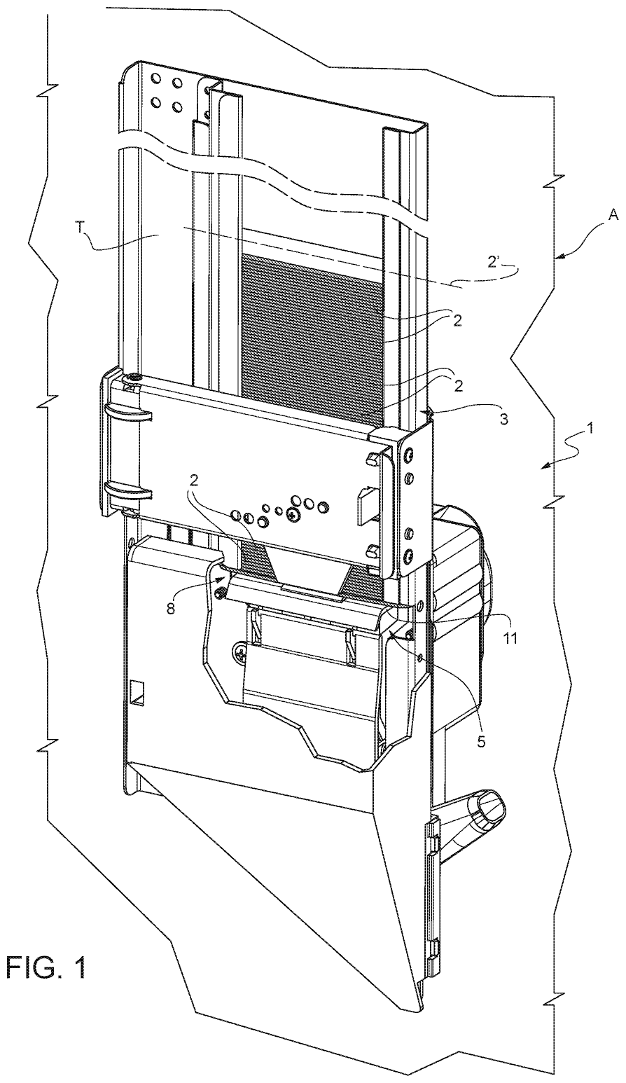

FIG. 1 shows a beverage vending machine, which is only to a partially illustrated and referenced as a whole with reference sign A.

The beverage vending machine A comprises a stir stick dispenser 1 operable to automatically dispense individual stir sticks 2 in a cup B to be filled with a beverage.

The stir sticks 2 of the example described in the present description and shown in the appended figures are in the form of elongated flat elements, each having a longitudinal axis 2′ and comprising two rounded end portions 2A and an intermediate portion 2B delimited by two larger flat faces 2B1 and two straight and thin flanks 2B2. Although this is the most adopted shape for stir sticks 2, that in this shape are also usually referred to as stirrers, however, the stir stick dispenser 1 of the present invention is also configured to dispense stir sticks having size or shape that is different from the ones of stir sticks of the illustrated example. For example, the stir sticks 2 may not be flat or only partially flat and/or have a circular cross-section or the like.

The stir stick dispenser 1 comprises a fixed attachment frame T and a stir stick magazine 3 where a stack 4 of orderly stacked and weight-loaded stir sticks 2 is arranged.

The stir stick dispenser 1 further comprises an extractor 5 arranged under the stir stick magazine 3 and having an upper support surface 6, on which, when the extractor 5 is in a rest position, the stack 4 of stir sticks 2 in the stir stick magazine 3 is resting.

The extractor 5 comprises a pusher 7, which is mounted to move back and forth, with respect to the stir stick magazine 3, so as to laterally engage the stir stick 2 resting on the support surface 6 in order to push it transversally through an outlet 8 of the stir stick magazine 3 until the stir stick 2 is completely extracted from the stack 4 and free to fall downwards.

In the preferred embodiment illustrated in the accompanying figures, the support surface 6 and the pusher 7 are integral and are both formed on the extractor 5 that is, in this case, is in the form of a swivelling member hinged to the frame T to reciprocatingly pivot about a fixed axis 9 parallel to the longitudinal axis 2′ of the stir sticks 2 in the stir stick magazine 3.

In particular, the extractor 5 comprises an arm 10 having a lower end portion hinged to the frame T to pivot about the fixed hinge axis 9 and an upper head portion 11 connected to an upper end of the arm 10.

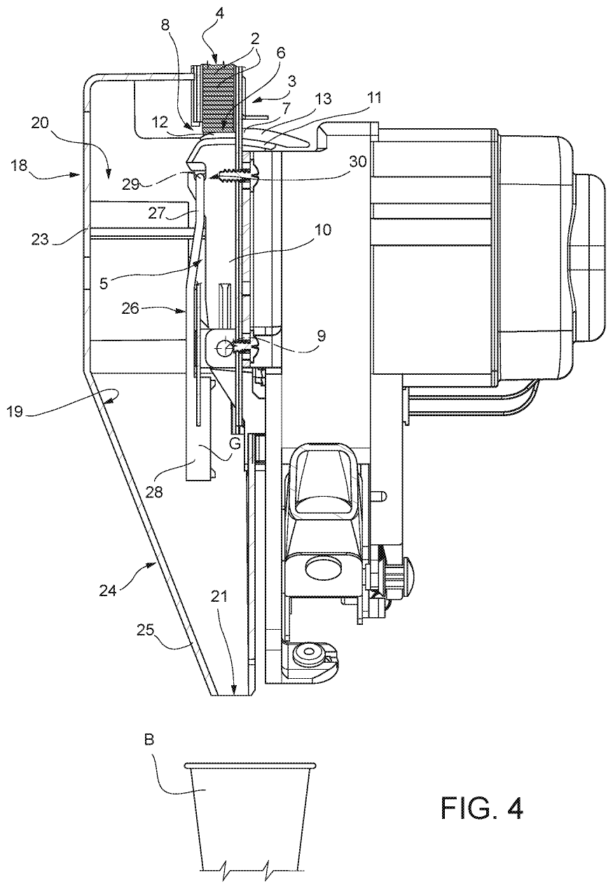

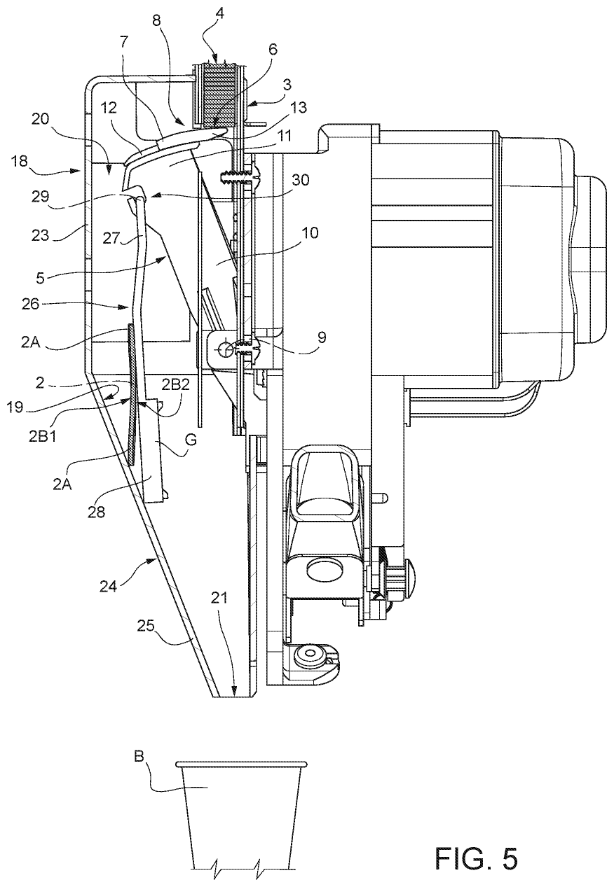

In particular, as shown in FIGS. 4 and 5, the head portion 11 comprises a lowered or support portion 12, whose upper surface forms said support surface 6, and a raised portion 13, which is arranged, in the rest position of the extractor 5, on the opposite side of the stir stick magazine 3 with respect to the outlet 8.

The lowered portion 12 and the raised portion 13 are mutually connected by a step, which extends parallel to the axis 9 and to the longitudinal axis 2′ of stir sticks 2 and has a height that is lower than, or at most equal to, the thickness of a stir stick 2.

The step between the lowered portion 12 and the raised portion 13 forms said pusher 7 operable to eject the stir stick 2 at the bottom of the stack 4 in response to the oscillation of the swivelling member 5 about the axis 9.

For this purpose, the swivelling member 5 is operated by an electric actuator (not shown) which is connected, preferably through an oscillating cam transmission (not shown) and electronically controlled by an electronic control unit of the beverage vending machine and configured to cause the swivelling member 5 to move between the retracted rest position (FIG. 4), in which the stir sticks 2 rest on the support surface 6, and the step, i.e., the pusher 7, is facing the stir stick 2 at the bottom of the stack 4, and an advanced extraction position (FIG. 5), in which the swivelling member 5 is rotated forwards, i.e., counter-clockwise in FIGS. 4 and 5, to such an extent that the pusher 7 is arranged beyond the outlet 8 of the stir stick magazine 3.

While moving between the retracted rest position and the advanced extraction position, the pusher 7 engages a flank of the stir stick 2 resting on the support surface 6 and pushes it in an extracted direction orthogonal to the hinge axis 9 and transversal to the longitudinal axis 2′ through the outlet 8 of the stir stick magazine 3 until the stir stick 2 is ejected from the stack 4. When the extraction position is reached, the swivelling member 5 returns to the rest position, preferably under the urge of a spring.

During the extraction of a stir stick 2, the stack 4 is supported by the raised portion 13 of the extractor 5 and returns resting on the lowered portion 12 when the swivelling member 5 returns to the rest position.

Thus, in the above-described embodiment, the extractor 5 comprises a lowered portion 12 and a raised portion 13 that move integrally as parts of an oscillation member.

In an alternative embodiment (not shown), when the extractor 5 is in the rest position, the stack 4 rests on the upper surface of the raised portion 13 instead of the lowered portion 12, and the extractor 5 is controlled to eject a stir stick 2 at the bottom of the stack 4 during the return stroke instead of during the forward stroke of the extractor 5. Also in this embodiment, the lowered portion 12 can be integral to the raised portion 13, thus movable with it, or stationary.

Regardless of the configuration of the extractor 5, the support surface 6 is so sized as to engage only a central portion of the stir stick 2 at the bottom of the stack 4, i.e., the width of the support portion 6, measured in the direction parallel to the longitudinal axis 2′ of the stir sticks 2, is such that it such that the stir stick 2 at the bottom of the stack 4 is in contact with the support surface 6 only at a central portion 2B of the stir stick 2 and not all along the length thereof.

Still with reference to FIGS. 4 and 5, the stir stick dispenser 1 further comprises a front shaped casing 18, which surrounds the extractor 5 and defines a drop chute 19 to guide the extracted stir stick 2 into the cup B.

The drop chute 19 has an inlet 20 adjacent to the head portion 11 of the extractor 5 and is configured to receive a stir stick 2 at a time from the extractor 5 and an outlet 21 arranged below the inlet 20 and in the proximity of the upper end of the cup B and is configured to supply the stir stick 2 in the cup B.

In particular, the shaped casing 18 comprises a substantially vertical, constant cross-section upper part 23 delimiting the inlet 20, and a downwards-tapered lower part 24 delimiting the outlet 21 and having a front wall 25 inclined downwards and towards the frame T and forming a guide chute to guide the stir stick 2 towards the outlet 21.

Still with reference to FIGS. 4 and 5, the stir stick dispenser 1 further comprises a movable member 26 operable to temporarily stop each stir stick 2 during its drop towards the outlet 21.

The movable member 26 is arranged inside the drop chute 19 astride of the parts 23 and 24 and is hung onto the head portion 11 of the extractor 5 like a pendulum or rocking element.

The movable member 26 is formed by a shaped plate body and comprises an upper plate 27, whose upper end is hinged to the head portion 11 to rotate about a horizontal hinge axis 29 stationary with respect to the head portion 11, and a lower end firmly connected to a stop block 28.

The position of the hinge axis 29 on the head portion 11 is chosen so that when the swivelling member 5 is in the retracted position, the distance of the hinge axis 29 from the frame T measured in a horizontal direction is greater than the distance of the hinge axis 9 from the frame T measured in the same direction.

The stop block 28 is conveniently formed by a plate body, which has a thickness greater than that of the upper plate 27 and is arranged facing the wall 25 that defines the guide chute.

Conveniently, a front part of the head portion 11 forms a hook 30 and the upper plate 27 has two intermediate fulcrum pins inserted in the hook 30 through a front passage. In this way, the movable member 26 is free to freely oscillate back and forth about the hinge axis 29. This allows the movable member 26 to rotate autonomously, i.e., only under the sole effect of its weight, only during the movement of the swivelling member 5.

In particular, the inclination of the guide chute, the vertical dimension of the movable member 26 and its centre of gravity G are chosen in such a way that, when the extractor 5 is in its advanced extraction position, the movable member 26 is arranged in an advanced operating position such that the stop block 28 is arranged in abutment against the guide chute to temporarily stop the stir stick 2 in the drop chute 19, and when the extractor 5 is in its retracted position or in a position close thereto, the movable member 26 is arranged in an inoperative or rest position in which it allows the stir stick 2 to advance inside the drop chute 19 towards the outlet 21.

From the foregoing it is evident that the provision of the movable member 26 and its autonomous and automatic positioning by the sole effect of the weight allow in an extremely simple and safe way transforming the free drop motion of the stir stick 2 present in the known solutions into a controlled drop motion. In other words, the presence of the movable member 26 allows annulling at a predefined point of the drop path, which can be chosen by simply sizing the geometric characteristics of the movable member 26 and of the guide chute, the drop speed of the stir stick 2 and controlling the intensity of the impact of the stir stick inside the cup B.

In addition to this, the movable stop member 26 defines a further rest plane or an abutment and control element of the position of the stir stick 2. Such further rest plane defines, in particular, a further guide of the stir stick 2 which cooperates with the inclined plane defining during its movement towards its rest position an intermediate passage with variable section which inevitably guides with precision the stir stick 2 towards the outlet 21 and in a desired inlet direction in the cup B.

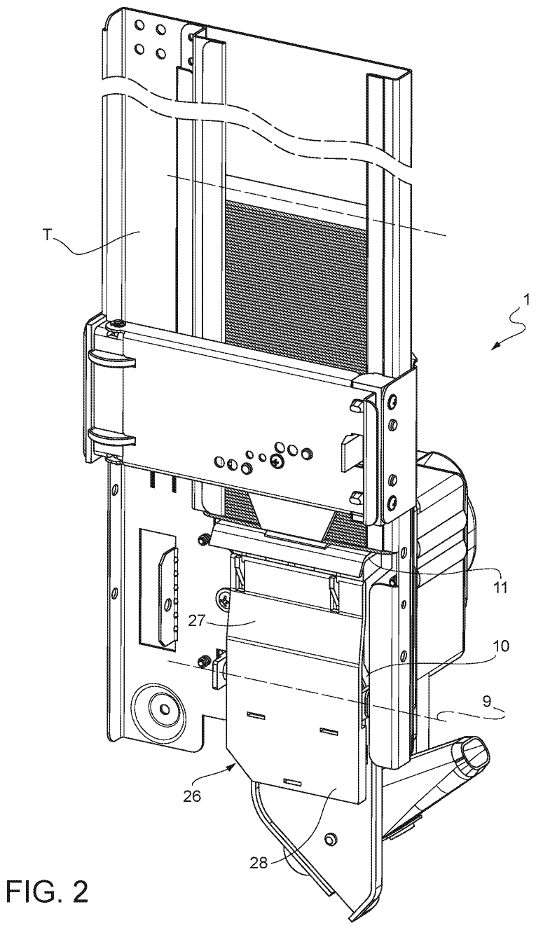

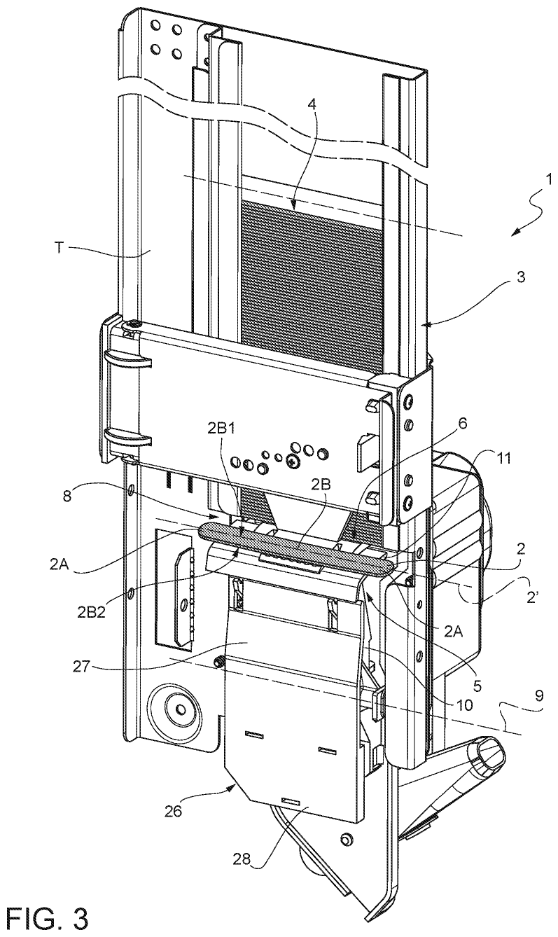

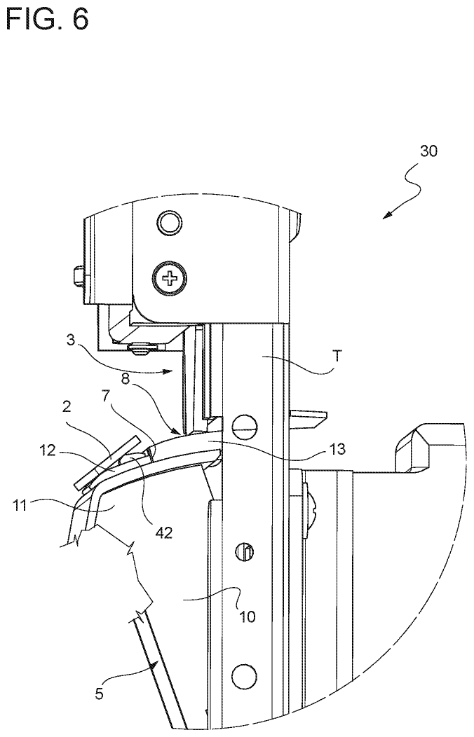

The variant shown in FIG. 6 relates to a stir stick dispenser 30, which differs from the stir stick dispenser 1 shown in FIGS. 1 to 5 for some construction details and whose constituent parts are indicated, where possible, by the same reference numerals as the corresponding parts of the stir stick dispenser 1.

The stir stick dispenser 30 comprises an extractor 31, which differs from the extractor 5 in that the head portion 11 comprises, in addition to the lowered portion 12 and the raised portion 13, a rocker extraction lever 33 to move away the stir stick 2 extracted from the head portion 11 and push it towards the inlet 20 of the drop chute 19.

The extraction lever 33 is arranged within a partial housing seat 34 formed in the head portion 11 between the lowered portion 12 and the raised portion 13.

The seat 34 communicates with the outside upwards and through two openings 35 and 36 mutually separated by a wall 37 integral with the raised portion 13.

The extraction lever 33 has an intermediate portion 38 arranged below the wall 37 and hinged to the head portion 11 to oscillate about a fixed hinge axis 39 parallel to the axis 9.

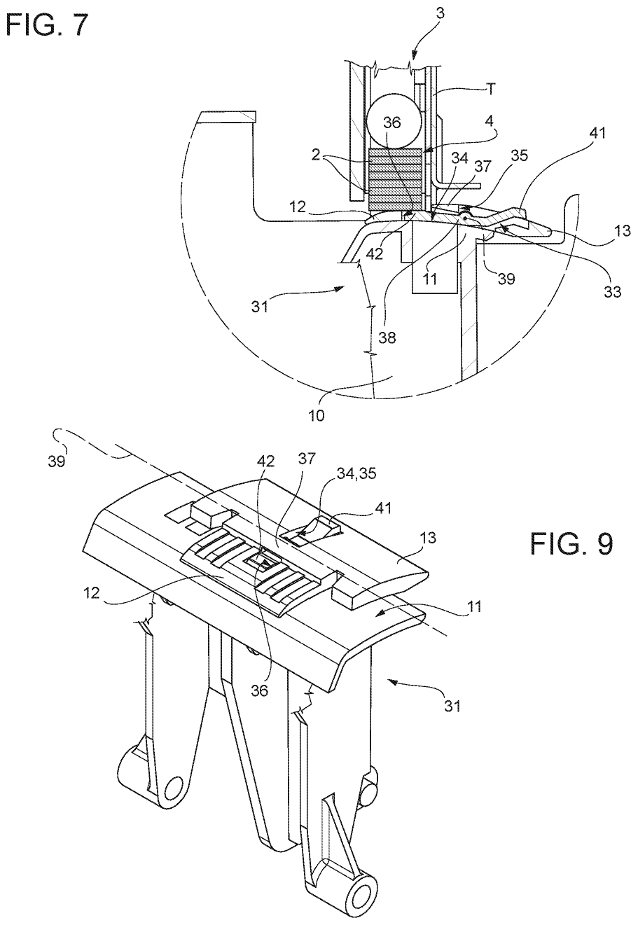

The extraction lever 33 comprises two opposite end portions 41 and 42, which are shaped in such a way that when one is raised and external to the head portion 11 the other is lowered and inserted into the seat 34 and vice versa, as shown in FIGS. 7 to 10.

During operation, when the extractor 31 is in its retracted position, shown in FIG. 7, the portion 42 is kept in a lowered position by the stir sticks 2 resting on the lowered portion 12 and, consequently, the portion 41 protrudes upwards through the opening 35 and beyond the rest plane of the raised portion 13, as shown in FIG. 7.

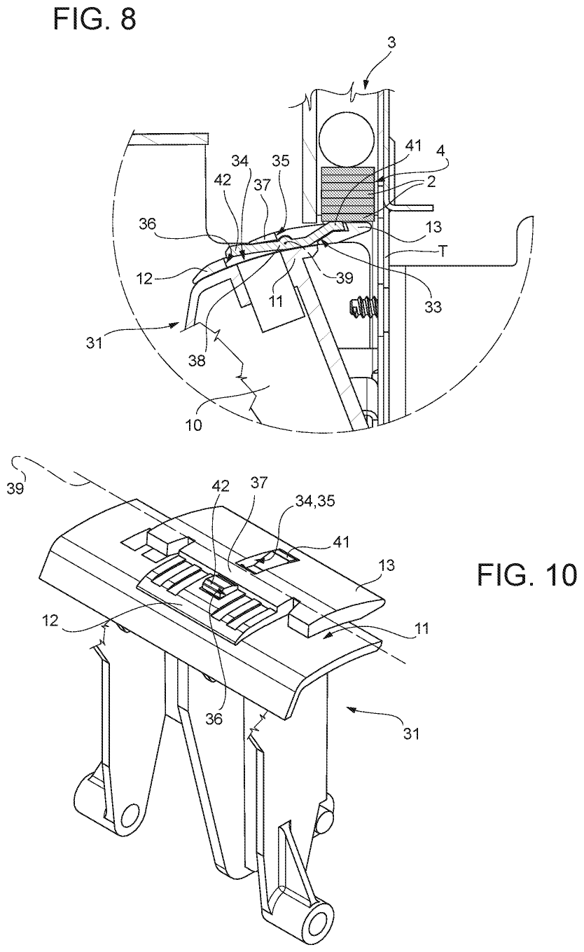

When the extractor 32 is in its advanced position, shown in FIG. 8, the portion 41 is kept by the stack 4 of stir sticks 2 in the seat 34, i.e., in a lowered position in the seat 34, and the portion 42 is raised and protrudes upwards through the opening 36 and beyond the rest plane of the lowered portion 12, as shown in FIG. 8.

As shown in FIGS. 6 and 8, the protrusion of the portion 42 through the opening 36 causes the lifting of the rear part of the stir stick 2 extracted from the stack 4, the spacing apart of the stir stick 2 from the lowered portion 12 and from the step between the portions 12 and 13 and the consequent pushing of the stir stick 2 inside the drop chute 19.

The provision of the extraction lever 33 always ensures the detachment of the stir stick 2 extracted from the stack 4 whatever the geometric characteristics of the stir stick 2 are and regardless of the material with which the stir stick 2 is made.

From the foregoing it may be appreciated that in the stir stick dispenser 1 the geometry and the size of the movable member 26 as well as the relative position of the hinge axes 9 and 29 can be different from those exemplarily described, with the purpose of varying or modifying the height of the interception point of the stir stick 2 along the drop chute 19 so as to vary the advancing motion profile thereof.

In the stir stick dispenser 30, the geometry of the extraction lever 33 could be different and the extractor 31 could be devoid of the movable member 26 or be provided or associated with a stop device different from the one indicated for the stir stick dispenser 1.

1-12. (canceled)

13. A stir stick dispenser for a beverage vending machine; the stir stick dispenser comprising:
a fixed frame;
a stir stick magazine carried by the fixed frame and configured to house a stack of stir sticks resting on a support surface;
an extractor arranged below the stir stick magazine to individually extract the stir sticks from the stack; wherein the extractor is coupled to the fixed frame and is motorized to move in an extraction direction transversal to a longitudinal axis of the stir sticks between a retracted rest position, in which the stir stack is resting on the support surface, and an advanced extraction position, in which the stir stick at the bottom of the stack is extracted;
a drop chute having an inlet adjacent to the extractor to receive therefrom one stir stick at a time and an outlet arranged below the inlet to supply the stir stick into an underlying beverage container; and
a movable stopping member arranged inside the drop chute and back and forth movable therein to temporarily stop the stir stick as the stir stick drops towards the outlet; the movable stopping member carried by the extractor and configured to cooperate in abutment against the stir stick.

14. The stir stick dispenser of claim 13, wherein the movable stopping member is hinged to the extractor to rotate about a hinge axis movable together with the extractor.

15. The stir stick dispenser of claim 14, wherein the hinge axis is arranged horizontally.

16. The stir stick dispenser of claim 15, wherein the movable stopping member is a pendulum member that extends downward from the hinge axis and is free to oscillate about the hinge axis.

17. The stir stick dispenser of claim 16, wherein the drop chute is delimited by a fixed wall extending from the outlet and the pendulum member is arranged at least partly facing the fixed wall and is movable with respect to the fixed wall between a retracted rest position, in which the pendulum member allows the transit of the stir stick within the drop chute, and an advanced operating position, in which the pendulum member cooperates with the fixed wall to temporarily stop the stir stick within the drop chute.

18. The stir stick dispenser of claim 14, wherein the extractor comprises a swivelling member hinged to the frame to reciprocatingly swivel about a further hinge axis stationary with respect to the frame and parallel to the hinge axis and arranged in a lowered position with respect to the hinge axis; the hinge axis is arranged at a distance from the frame greater than a distance of the further hinge axis from the frame measured in the same direction, so that the mobile member automatically arranges in an advanced retention position thereof when the extractor is in an advanced position thereof and returns to the rest position when the extractor is in a retracted position thereof.

19. The stir stick dispenser of claim 13, wherein the movable stopping member is formed by a shaped plate body.

20. A beverage vending machine comprising the stir stick dispenser according to claim 13.
